(19) United States
(12) Patent Application Publication
(10) Pub. No.: US 2007/0001157 A1
(43) Pub. Date: Jan. 4, 2007

(54) Conduit leader

(76) Inventor: Jon C. Quick, Black River Falls, WI (US)

Correspondence Address: RYAN KROMHOLZ & MANION, S.C., POST OFFICE BOX 26618, MILWAUKEE, WI, 53226, US

(21) Appl. No.: 11/478,061

(22) Filed: Jun. 29, 2006

Related U.S. Application Data
(60) Provisional application No. 60/695,057, filed on Jun. 29, 2005.

(51) Int. Cl. H02G 1/08

(52) U.S. Cl. 254/134.3 FT

(57) ABSTRACT

A device and method for leading objects through conduit are provided. A conduit leader is provided that is adapted to slide through a conduit and accept objects to be fed through a conduit run. The leader has a bore formed therein to accept objects and a securing means to secure the objects to the leader. The leader is preferably formed from a material that is at least as indurate as the conduit into which the objects are to be fed. The method of using the leader enables a single person to feed objects into a conduit and eliminates several steps required by previous processes used in the art.

### RELATED APPLICATION

This application claims the benefit of co-pending U.S. Provisional Patent Application Ser. No. 60/695,057, filed Jun. 29, 2005.

### BACKGROUND OF THE INVENTION

The invention relates generally to electrician tools, and, more particularly, to electrician tools providing the capability of feeding cable or other items through conduit.

It is well known in the art of running electrical cable through conduit by using a fish-tape or similar device. A fish-tape is generally longitudinally stiff, and radially semi-stiff, and is usually constructed of a length of flat metal. The fish-tape is used by starting at an exit point of a conduit run and feeding the tape towards an entrance point. The longitudinal stiffness aids in pushing the tape through the conduit and the radial flexibility allows the tape to maneuver corners.

The user must then proceed to the entrance point of the conduit. The user fastens electrical cable, or other item to be run through the conduit, to the fish-tape and proceeds back to the exit point. Only then can the user begin to pull the fish-tape and item fastened thereto through the conduit.

As described, the process of using a fish-tape takes many steps. The process is hastened generally by the employ of additional workers.

Therefore, the art of feeding items through-conduit could be improved by a device that eliminates undesirable additional feeding steps and allows a single worker to feed items efficiently.

It is also well known in the electrical arts to provide an insulated, threaded electrical connector so as to allow a solderless electrical connection between adjacent wires. However, generally the insulating material used in conjunction with such connectors is not sufficiently hardened, or indurate, to withstand encounters with rough metal conduit edges and the like. Such material would be deformed by dents or deep scratches, and the deformation would negatively affect the leading capability of such a device. Furthermore, insulating material is prone to cracking or breakage which would lead to catastrophic failure of the device.

Thus, the art of feeding items through conduit could be improved by a device that is sufficiently indurate so as to withstand all but only superficial scratches when physical encounters with metal or other sharp surfaces occur.

### SUMMARY OF THE INVENTION

The present invention is directed to a device that satisfies the needs defined above. A conduit leader having features of the present invention comprises a body having a closed end and an open end. The closed end is sized to fit into a conduit. The open end is sized to accept an item to be fed through the conduit. The open end is formed from a bore, which is created in the body of the leader. At least partially within, or in communication with, the bore is located a means for engaging the item to be fed through the conduit. Around the open end is a bore perimeter, which is also sized to fit into the conduit. Upon securing the leader to at least one item to be fed through a conduit, thereby forming a conductive or nonconductive junction, a single worker is able to push the item through the conduit as the leader allows guidance through conduit junctions and around corners.

### BRIEF DESCRIPTION OF THE DRAWINGS

These and other features, aspects, and advantages of the present invention will become better understood with regard to the following description and accompanying drawings where:

FIG. 1 is a perspective partially cut-away view of a prior art device.

FIG. 2 is a perspective view of a first embodiment of the invention.

FIG. 3 is a side elevation view of a second embodiment of the invention.

FIG. 4 is a top plan view of the embodiment of FIG. 3.

FIG. 5 is a cross-sectional view taken along line 5-5 in FIG. 4.

FIG. 6 is a side elevation view of a third embodiment of the invention.

FIG. 7 is a cross-sectional view taken along line 7-7 in FIG. 6.

FIG. 8 is a side elevation view of a fourth embodiment of the invention.

### DESCRIPTION OF THE PREFERRED EMBODIMENT

Referring to FIG. 1, a prior art device 9 is comprised of an insulating sheath 3, an internal housing 5, and a spring thread 7. The purpose of the device 9 is to provide a solderless, conductive and insulated electrical connection to two or more cables or wires 90. The insulating sheath 3 is necessary to prevent conduction between the connected wires 90, the spring thread 7, the housing 5 and any ambient structure (not shown) that may come in contact with the junction. Relative to a conduit, such insulating sheath lacks sufficient strength and would be prone to failure. Further, it is noted that the spring thread 7 continues along the entire length of the housing 5 disposed in the insulating sheath 3. Also evident from FIG. 1 is a blunt nose 2 and sharp, flared trailing edge 4 of the prior art device. The blunt nose 2 is not conducive to pushing through a conduit and the sharp trailing edge 4 significantly impedes retrieval, thereby perhaps causing such a device to become lodged in a conduit; a situation that would require significant labor to correct. Finally, the longitudinal flutes 6 would be prone to getting caught on obstructions.

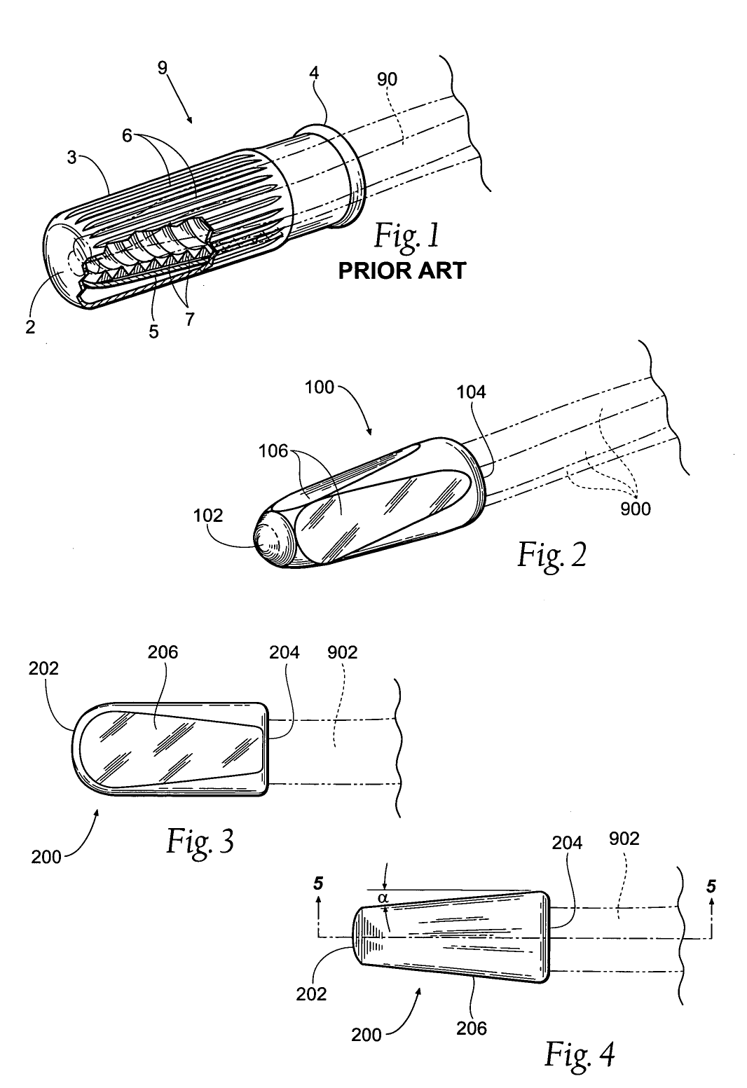

Referring to FIG. 2, one embodiment 100 of the present invention is depicted. The leader 100 has a closed end 102 and an open end 104. The leader 100 is preferably cylindrical in shape and may have a plurality of faceted sides 106, which can serve as a gripping means. The leader 100 is constructed of a rigid material such as steel or other material sufficiently indurate to withstand all but superficial scratches. The leader 100 can be formed by any method well known in the art of forming the chosen material, such as casting or machining, or a combination thereof.

The closed end 102 is preferably a convex shape. Generally, when faceted sides 106 are employed, the closed end 102 will be smaller, in surface area, than the open end 104. Although the surface area covered by the closed end 102 is not required to be smaller than that of the open end 104, such asymmetrical cross-sectional size would enable the leader 100 to act as a wedge as it is being fed through a conduit.

The open end 104 is preferably generally circular in shape, and sized to accept items 900 to be led through a conduit run. Although FIG. 2 depicts multiple items 900, it is contemplated that the leader 100 may be sized to accommodate only a single item 902, as is shown in FIGS. 3, 4, and 5.

Referring now to FIGS. 3 and 4, a second embodiment 200 of the present invention is shown. The leader 200 has only two faceted sides 206, as an alternative to the four faceted sides 106 of the embodiment in FIG. 2 (only two of which can be seen). The faceted sides 106,206 can be formed at any desirable angle (α). However an angle α greater than forty-five degrees would likely impede the leading capabilities. Generally, an angle a of between five and fifteen degrees works well.

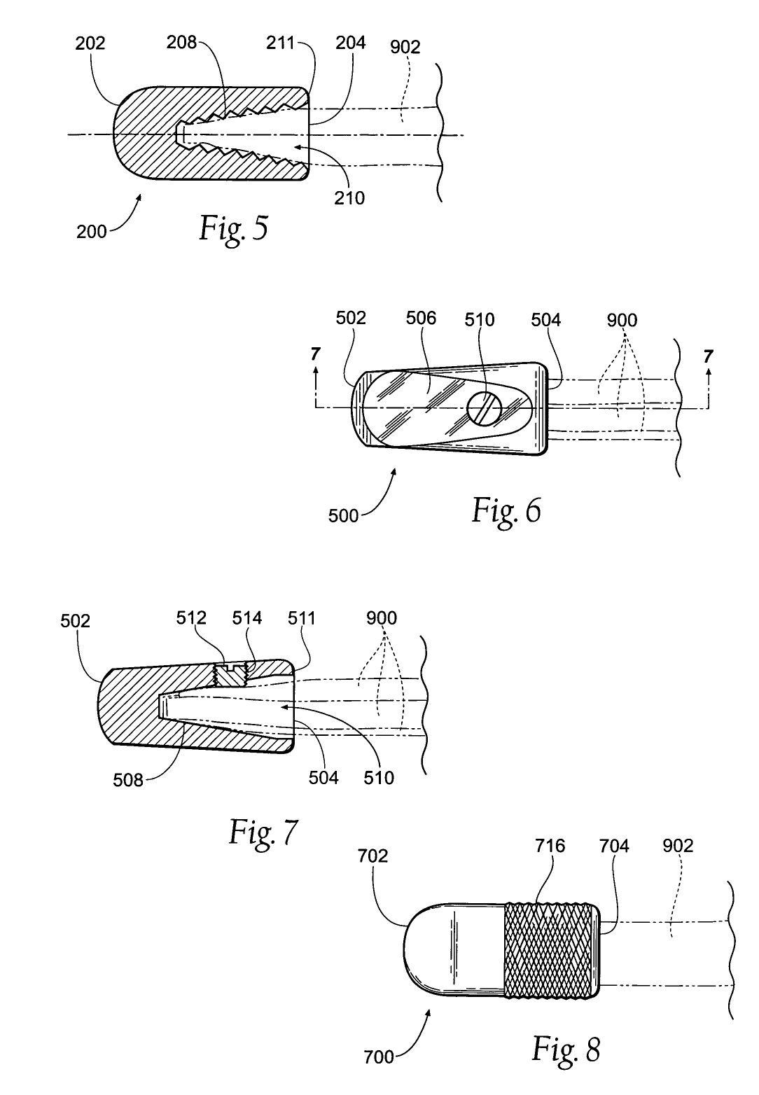

FIG. 5 depicts a cross-sectional view of the embodiment of FIGS. 3 and 4, taken along line 5-5 in FIG. 4. A similar cross-section would be seen if leader 100 were sectioned. The leader 200 is provided with a bore 210 having threads 208 disposed therein. Although the bore 210 is depicted as tapered, it is contemplated that a different bore could be formed as long as the threads 208 are spaced to properly engage the object 902. Casting or machining could be used to form the bore 210. Thus, this embodiment is preferably of a unitary single piece construction. The threads 208 are sufficiently spaced to engage the objects 900 or object 902 to be led through conduit. Around the bore 210 is left a bore perimeter 211. The bore perimeter 211 preferably has edges that taper back towards the item 902 so as to allow easy extraction from a conduit if necessary. The preferred taper is a simple rounded edge 211. Furthermore, as can be seen in FIG. 5, it is desirable to maintain, proximate the closed end 202, a solid portion of the device 200 into which the bore 210 does not protrude. The solid portion adds strength and mass to the device 200 to aid in leading items through conduit. While varying amounts of material could be used, it is preferable that at least approximately fifteen percent of the length of the device 200 be maintained solid or reinforced in some manner.

FIG. 6 provides another alternative embodiment 500 of the present invention, and FIG. 7 shows a cross section of this alternative embodiment 500 taken along line 7-7 in FIG. 6. Referring to FIGS. 5 and 7, instead of utilizing only threads 208 within the bore 210, the leader 500 is provided with a bore 510 and a setscrew 512. Since the setscrew 512 engages the items 900 to be fed through a conduit, the bore 510 of this embodiment does not need threads 208 and may instead form a smooth interior surface 508.

To make the leader 500, the general cylindrical shape and bore 510 can be formed from any method well known in the art such as casting or machining. Although the bore 510 is depicted as tapered, it is contemplated that a straight bore could also be used. After the general shape is achieved, faceted sides 506 are formed, if the sides 506 were not formed during the casting or machining steps. A threaded aperture 514 is then created in the leader 500, preferably on a faceted side 506 if one is provided.

FIG. 8 provides yet another embodiment 700 of the present invention. This embodiment provides a leader 700 having a generally cylindrical shape with a closed end 702 and an open end 704. The closed end 702 is preferably convex to facilitate the leading function. The outer surface of the leader 700 may be provided with a gripping means 716, such as knurling. While pictured as incorporating the engaging means similar to that of FIG. 5, it is contemplated that this leader 700 design could be used with other engaging means.

Referring to FIGS. 2-8, the leader 100 is fastened to the item to be led through a conduit or similar structure. In the case of leader 100, 200 or 700, it is simply twisted onto the items 900 or item 902 with the user's hand, thereby engaging the items 900 or item 902 with the threads 208 in the bore 210. In using the leader 500, it would first be worked onto the items 900 or item 902 and the setscrew 512 would then be turned into the bore 510 thereby creating a frictional pressure engagement of the items 900 or item 902.

Once a leader is fastened to the items 900 or item 902 to be fed through a conduit, the user simply approaches a conduit entrance point and places the leader into the conduit and begins pushing the items 900 or item 902 into the conduit using the leader as a guide. The process continues until at least a portion of the leader is exposed or retrievable at a conduit exit. This process eliminates the step of feeding a fish-tape from the exit point and provides the efficient feeding of items into conduit by one person.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A device for guiding a flexible member through a conduit, said device comprising:
a leader body having an open end and a closed end;
a bore forming an inner surface adapted to receive said member and extending at least partially into said leader body from said open end; and
a securing means disposed in said leader body, said securing means adapted to secure said member to the leader body.

2. The device of claim 1 wherein said leader body has an outer surface and said device further comprises a gripping means disposed on said outer surface.

3. The device of claim 1 wherein the open end is circular.

4. The device of claim 1 wherein the closed end is convex.

5. The device of claim 2 wherein the gripping means comprises at least one facet formed on the outer surface of said leader body.

6. The device of claim 5 wherein the leader body is formed about a longitudinal axis and the at least one facet is formed at an angle less than forty-five degrees relative to said longitudinal axis.

7. The device of claim 1 wherein at least a portion of the leader body comprises a material which is at least as indurate as said conduit.

8. The device of claim 1 wherein the securing means is a thread disposed on the inner surface of the bore.

9. The device of claim 8 wherein the thread is formed integrally with the leader body.

10. The device of claim 1 wherein the bore is tapered.

11. The device of claim 1 wherein the leader body is formed about a longitudinal axis and the securing means comprises a set screw operable through a side wall of the leader body.

12. The device of claim 2 wherein the gripping means comprises knurling.

13. The device of claim 1 wherein at least twenty percent of the leader body length proximate the closed end is adapted to preclude said object.

14. The device of claim 1 wherein said member comprises at least one electrical wire.

15. The device of claim 1 wherein said member comprises at least one fiber optic cable.

16. A method comprising the steps of:
fastening a leader body onto an object thereby creating a connection;
feeding the leader body followed by the object into a conduit run; and
pushing the object led by the leader body into the conduit run.

17. The method of claim 16 wherein said connection is electrically non-conductive.

18. The method of claim 16 wherein said object comprises at least one electrical wire.

19. The method of claim 16 wherein said object comprises at least one fiber optic cable.

20. A device for guiding a flexible member through a conduit, said device comprising:
a leader body having an open end, a closed end, and one piece unitary construction;
a bore forming an inner surface adapted to receive said member and extending at least partially into said leader body from said open end; and
a securing means disposed in said leader body, said securing means adapted to secure said member to the leader body.
